(19) United States
(12) Patent Application Publication
(10) Pub. No.: US 2017/0159625 A1
(43) Pub. Date: Jun. 8, 2017

(54) INJECTOR SEALS FOR DUAL FUEL APPLICATION

(71) Applicant: Caterpillar Inc., Peoria, IL (US)

(72) Inventors: Adrienne M Brasche, Peoria, IL (US); Sunil J. Bean, Peoria, IL (US)

(73) Assignee: Caterpillar Inc., Peoria, IL (US)

(21) Appl. No.: 14/961,944

(22) Filed: Dec. 8, 2015

(51) Int. Cl. F02M 43/04; F02M 61/10; F02M 37/00

(52) U.S. Cl. CPC F02M 43/04; F02M 37/0064; F02M 61/10

(57) ABSTRACT

A dual fuel injector configuration is provided that includes a plurality of seals around a fuel check needle to prevent transfer of a gaseous fuel to portions of the injector intended for handling of liquid fuel, prevent transfer of liquid fuel to portions of the injector intended for handling of gaseous fuel, or a combination thereof. At least one seal can correspond to a pressure-assisted sealing member suitable for sealing against transfer of liquid fuel. At least one additional seal can correspond to a pressure-assisted sealing member suitable for sealing against transfer of gaseous fuel. The sealing members can be separated by a backing member that provides structural support for one or both of the sealing members. The volume occupied by the backing member can also include a conduit to an external surface of the injector.

### TECHNICAL FIELD

The present disclosure relates generally to dual fuel common rail systems, and more particularly to a dual fuel injector having a plurality of fuel check valves.

### BACKGROUND

Dual fuel injectors allow for introduction of multiple types of fuel into a combustion chamber. Although the dual fuels are combusted in a common combustion chamber environment, the multiple fuels are not necessarily delivered to the combustion chamber under similar conditions. Depending on the nature of each fuel, different fuels may be delivered into the combustion environment at different pressures. The fuels may also be in different phases when delivered to the environment, such as having a first fuel delivered as a liquid phase fuel while at least a portion of a second fuel is delivered as a gas phase fuel.

Some dual fuel injectors can include a separate check valve for each fuel that operates to inject each fuel without interference from the other. For such dual fuel injectors, it may be desirable to use one of the fuels, such as a condensed phase fuel, as the fluid for controlling the operation of the check valves in the fuel injector. However, this can present difficulties with undesired mixing of liquid fuel into a portion of the injector dedicated to handling a gaseous fuel, or introduction of a gaseous fuel into a portion of the injector dedicated to handling a liquid fuel.

U.S. Pat. No. 8,978,623 attempts to address the above issues for a dual fuel injector with concentric fuel check valves. A concentric dual fuel injector is described that includes a sealing member around the diesel fuel check to prevent diesel fuel from leaking from the diesel fuel check cavity into the gaseous fuel orifice. However, it would be desirable to provide a more efficient dual fuel injector that substantially prevents mixing of fuels in undesirable locations within the fuel injector. The present disclosure is directed toward one or more of the problems set forth above.

### SUMMARY

In accordance with one embodiment, a dual fuel injector is provided. The dual fuel injector includes an injector body, a nozzle, a first-fuel check needle, a second-fuel check needle, a first sealing member, a second sealing member, a backing ring disposed in an intermediate volume, and a conduit from the intermediate volume to an exterior surface of a fuel check guide. The injector body is configured to receive a first fuel and a second fuel. The nozzle has a first set of orifices for injecting the first fuel and a second set of orifices for injecting the second fuel. The first-fuel check needle is at least partially disposed in a first-fuel check reservoir. The second-fuel check needle is at least partially disposed in a second-fuel check cavity and at least partially disposed in the first-fuel check reservoir. The first sealing member is disposed around the exterior of the second-fuel check needle. The first sealing member is configured to prevent the first fuel from leaking from the first-fuel check reservoir into the second-fuel check cavity. The second sealing member is disposed around an exterior of the second-fuel check needle and between the second-fuel check cavity and the first-fuel check reservoir. The second sealing member is configured to prevent the second fuel from leaking from the second-fuel check cavity into the first-fuel check reservoir. The backing ring is disposed around the exterior of the second-fuel check needle in an intermediate volume between the first sealing member and the second sealing member.

In accordance with another embodiment, a dual fuel common rail fuel system is provided. The dual fuel common rail fuel system includes a first-fuel source, a second-fuel source, a first-fuel rail, a second-fuel rail, at least one first-fuel pump, at least one second-fuel pump, and a dual fuel injector. The at least one first-fuel pump is configured to pressurize a first fuel from the first-fuel source and deliver the first fuel to the first-fuel rail. The at least one second-fuel pump is configured to pressurize a second fuel from the second-fuel source and deliver the second fuel to the second-fuel rail. The dual fuel injector is fluidly coupled to the first-fuel rail and to the second-fuel rail. The dual fuel injector includes an injector body, a nozzle, a first-fuel check needle, a second-fuel check needle, a first sealing member, a second sealing member, a backing ring disposed in an intermediate volume, and a conduit from the intermediate volume to an exterior surface of a fuel check guide. The injector body is configured to receive a first fuel and a second fuel. The nozzle has a first set of orifices for injecting the first fuel and a second set of orifices for injecting the second fuel. The first-fuel check needle is at least partially disposed in a first-fuel check reservoir. The second-fuel check needle is at least partially disposed in a second-fuel check cavity and at least partially disposed in the first-fuel check reservoir. The first sealing member is disposed around the exterior of the second-fuel check needle. The first sealing member is configured to prevent the first fuel from leaking from the first-fuel check reservoir into the second-fuel check cavity. The second sealing member is disposed around an exterior of the second-fuel check needle and between the second-fuel check cavity and the first-fuel check reservoir. The second sealing member is configured to prevent the second fuel from leaking from the second-fuel check cavity into the first-fuel check reservoir. The backing ring is disposed around the exterior of the second-fuel check needle in an intermediate volume between the first sealing member and the second sealing member.

In accordance with still another embodiment, a dual fuel engine system is provided. The dual fuel engine system includes a first-fuel source, a second-fuel source, a first-fuel rail, a second-fuel rail, at least one first-fuel pump, at least one second-fuel pump, and a dual fuel engine. The at least one first-fuel pump is configured to pressurize a first fuel from the first-fuel source and deliver the first fuel to the first-fuel rail. The at least one second-fuel pump is configured to pressurize a second fuel from the second-fuel source and deliver the second fuel to the second-fuel rail. The dual fuel engine includes at least one dual fuel injector fluidly coupled to the second-fuel rail and to the first-fuel rail. The at least one dual fuel injector includes an injector body, a nozzle, a first-fuel check needle, a second-fuel check needle, a first sealing member, a second sealing member, a backing ring disposed in an intermediate volume, and a conduit from the intermediate volume to an exterior surface of a fuel check guide. The injector body is configured to receive a first fuel and a second fuel. The nozzle has a first set of orifices for injecting the first fuel and a second set of orifices for injecting the second fuel. The first-fuel check needle is at least partially disposed in a first-fuel check reservoir. The second-fuel check needle is at least partially disposed in a second-fuel check cavity and at least partially disposed in the first-fuel check reservoir. The first sealing member is disposed around the exterior of the second-fuel check needle. The first sealing member is configured to prevent the first fuel from leaking from the first-fuel check reservoir into the second-fuel check cavity. The second sealing member is disposed around an exterior of the second-fuel check needle and between the second-fuel check cavity and the first-fuel check reservoir. The second sealing member is configured to prevent the second fuel from leaking from the second-fuel check cavity into the first-fuel check reservoir. The backing ring is disposed around the exterior of the second-fuel check needle in an intermediate volume between the first sealing member and the second sealing member.

### BRIEF DESCRIPTION OF THE DRAWINGS

FIG. 1 shows a cross-section of a dual fuel injector according to a first embodiment.

FIG. 2 shows a cross-section of a portion of the dual fuel injector according to the first embodiment.

FIG. 3 shows a detail view of a sealing configuration according to a second embodiment.

FIG. 4 shows a perspective view of a fuel check guide according to the second embodiment.

FIG. 5 shows an example of a backing ring according to a third embodiment.

FIG. 6 shows a detail view of a sealing configuration according to the third embodiment.

FIG. 7 shows an example of assembly of a backing ring into a fuel check guide according to the third embodiment.

FIG. 8 schematically shows an example of a fuel system incorporating a dual fuel common rail injector.

### DETAILED DESCRIPTION

In various aspects, a dual fuel injector configuration is provided that includes a plurality of seals around a fuel-check needle to prevent transfer of a gaseous fuel to portions of the injector intended for handling of liquid fuel, prevent transfer of liquid fuel to portions of the injector intended for handling of gaseous fuel, or a combination thereof. At least one seal can correspond to a pressure-assisted sealing member suitable for sealing against transfer of liquid fuel. At least one additional seal can correspond to a pressure-assisted sealing member suitable for sealing against transfer of gaseous fuel. The sealing members can be separated by a backing member that provides structural support for one or both of the sealing members. The volume occupied by the backing member can also include a conduit to an external surface within the injector, such as an exterior surface of a fuel check guide, so that any leaks of either fuel into the space between the sealing members can be detected at the exterior surface.

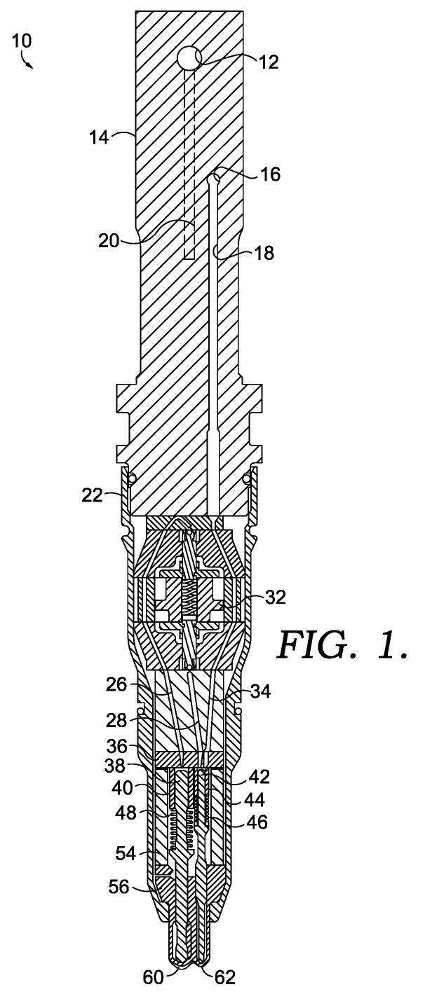

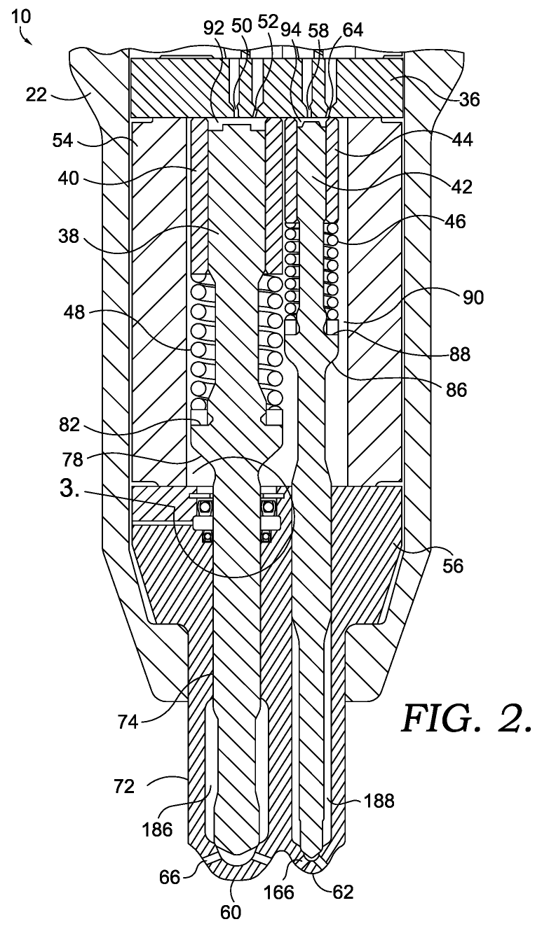

FIGS. 1 and 2 depict the internal structure and fluid circuitry of an injector 10 according to a first embodiment. In particular, an injector body 14 includes fuel supply inlets corresponding to a diesel-fuel supply inlet 16 (i.e., first-fuel supply inlet) and a gaseous-fuel supply inlet 12 (i.e., second-fuel supply inlet). Fuel can be delivered to diesel-fuel supply inlet 16 and gaseous-fuel supply inlet 12 in any convenient manner, such as by a quill assembly as described below.

Fuel delivered to diesel-fuel supply inlet 16 can be passed into various portions of the injector 10 in any convenient manner. For the embodiment shown in FIG. 1, injector body 14 further defines a diesel-fuel supply passage 18 to provide fluid communication between diesel-fuel supply inlet 16 and a diesel fuel supply line 34. Injector body 14 also includes a gaseous-fuel supply passage 20 that is not in the plane of the cutaway view in the embodiment shown in FIG. 1. More generally, any convenient number of passages can be included in injector body 14 for providing diesel fuel and/or gaseous fuel to desired locations within the injector. Exterior casing 22 can be composed of any convenient material for providing an exterior casing for at least a portion of the injector 10. For example, exterior casing 22 can be formed from a material with desirable properties for thermal management, chemical resistance, and/or any other convenient consideration.

As shown in greater detail in FIG. 2, injector 10 includes a diesel-fuel check needle 42 (i.e., first-fuel check needle) and a gaseous-fuel check needle 38 (i.e., second-fuel check needle). Injector 10 also includes a diesel-fuel check reservoir 90, the volume of which is defined by a reservoir side wall 54, a reservoir top wall 36, and a fuel check guide 56. Gaseous-fuel check needle 38 is at least partially disposed within diesel-fuel check reservoir 90, and at least partially disposed within gaseous-fuel check cavity 186. In between diesel-fuel check reservoir 90 and gaseous-fuel check cavity 186, gaseous-fuel check needle 38 passes through channel 74 in fuel check guide 56. Diesel-fuel check needle 42 is at least partially disposed within diesel-fuel check reservoir 90. Diesel-fuel check cavity 188 corresponds to a portion of diesel-fuel check reservoir 90, or diesel-fuel check cavity 188 can correspond to a separate volume that is optionally in fluid communication with diesel-fuel check reservoir 90. Diesel-fuel check needle also passes through fuel check guide 56. While the embodiment shown in FIG. 2 depicts a single fuel check guide, in some alternative embodiments a check guide for gaseous-fuel check needle 38 and a check guide for diesel-fuel check needle 42 may correspond to separate structures.

In the embodiment shown in FIG. 2, gaseous-fuel check needle 38 can be moved between at least a first position and a second position to control injection of gaseous fuel from gaseous-fuel check cavity 186 into an engine combustion chamber via nozzle 72. Gaseous-fuel check cavity 186 can receive gaseous fuel based on being in fluid communication, either directly or indirectly, with gaseous-fuel supply inlet 12. In a first position, gaseous-fuel check needle 38 blocks fluid communication between gaseous-fuel check cavity 186 and gaseous-fuel orifices 66 in nozzle tip 60. In a second position, gaseous-fuel check needle 38 can allow fluid communication between gaseous-fuel check cavity 186 and gaseous-fuel orifices 66. Similarly, diesel-fuel check needle 42 can be moved between at least a first position and a second position to allow for injection of diesel fuel from diesel-fuel check cavity 188 into an engine combustion chamber via diesel-fuel orifices 166 in nozzle tip 62. Diesel fuel can be supplied to diesel-fuel check cavity 188 based on diesel-fuel check cavity 188 being in fluid communication with diesel-fuel check reservoir 90. Alternatively, diesel-fuel check cavity 188 can be in fluid communication, either directly or indirectly, with diesel-fuel supply inlet 16 and/or diesel fuel supply line 34.

Gaseous-fuel check needle 38 and diesel-fuel check needle 42 can be movable between at least a first position and a second position. For example, a first position of the diesel-fuel check needle can correspond to a position that blocks fluid communication of diesel fuel into an engine combustion chamber, while a second position allows flow of a fuel into the engine combustion chamber. Similarly, a first position of the gaseous-fuel check needle can correspond to a position that blocks fluid communication of gaseous fuel into an engine combustion chamber, while a second position allows flow of a fuel into the engine combustion chamber. The movement of gaseous-fuel check needle 38 and/or diesel-fuel check needle 42 can be controlled in any convenient manner. In the embodiment shown in FIG. 2, the movement of gaseous-fuel check needle 38 can be controlled in part based on control chamber 92, biasing spring 48, and hydraulic surface 78. Biasing spring 48 is positioned between flange 82 and a second structure. The second structure can correspond to reservoir top wall 36 that defines a top of control chamber 92, a surface of separator 40 that separates diesel-fuel check reservoir 90 from control chamber 92, or another convenient structure. Biasing spring 48 biases the gaseous-fuel check needle 38 toward being in the first position. When the gaseous-fuel check needle 38 is in a first position, control chamber 92 can be filled with pressurized diesel fuel. The gaseous-fuel check needle 38 can be moved by removing at least a portion of the diesel fuel pressure from control chamber 92 through drain orifice 50. Drain orifice 50 and fill orifice 52 may be in selective fluid communication with control chamber 92, as will be discussed in greater detail below. The pressure of diesel fuel in diesel-fuel check reservoir 90 can act on hydraulic surface 78 to overcome the biasing force from biasing spring 48 and move gaseous-fuel check needle 38 from the first position toward a second position. After injection of gaseous fuel into a combustion chamber, gaseous-fuel check needle 38 can be returned to the first position by pressurizing the diesel fuel in control chamber 92 through fill orifice 52. Fill orifice 52 can be in fluid communication, for example, with diesel fuel supply line 34 (see FIG. 1).

The movement of diesel-fuel check needle 42 can be controlled in part based on control chamber 94, biasing spring 46, and hydraulic surface 86. Biasing spring 46 is positioned between flange 88 and a second structure. The second structure can correspond to reservoir top wall 36 that defines a top of control chamber 94, a surface of separator 44 that separates diesel-fuel check reservoir 90 from control chamber 94, or another convenient structure. Biasing spring 46 biases the diesel-fuel check needle 42 toward being in the first position. When the diesel-fuel check needle 42 is in a first position, control chamber 94 is filled with pressurized diesel fuel. The diesel-fuel check needle 42 can be moved by removing at least a portion of the diesel fuel pressure from control chamber 94 through drain orifice 58. Drain orifice 58 and fill orifice 64 may be in selective fluid communication with control chamber 94, as will be discussed in greater detail below. The pressure of diesel fuel in diesel-fuel check reservoir 90 can act on hydraulic surface 86 to overcome the biasing force from biasing spring 46 and move diesel-fuel check needle 42 from the first position toward a second position. After injection of diesel fuel into a combustion chamber, diesel-fuel check needle 42 can be returned to the first position by pressurizing the diesel fuel in control chamber 94 through fill orifice 64. Fill orifice 64 can be in fluid communication, for example, with diesel fuel supply line 34.

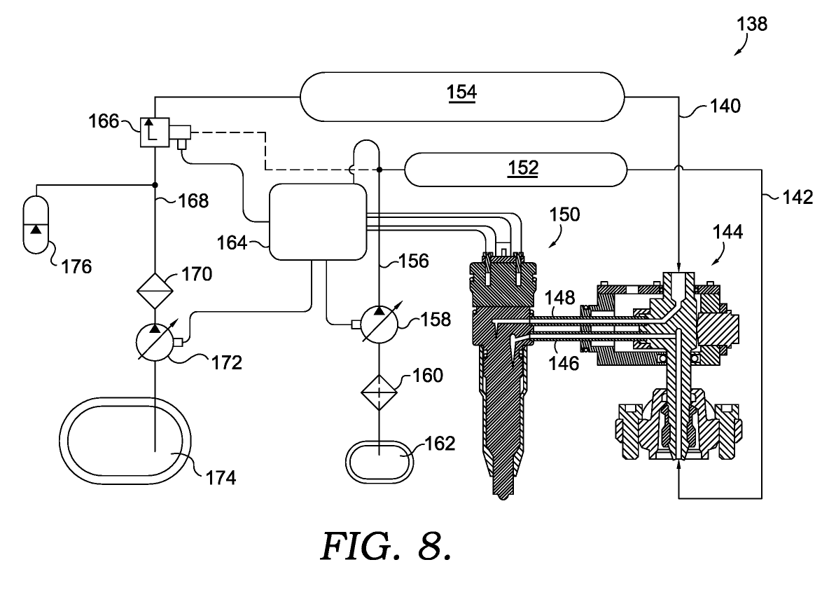

Returning to FIG. 1, the motion of gaseous-fuel check needle 38 and diesel-fuel check needle 42 can be operated by an electrical actuator 32, such as one or more solenoid actuators and/or piezo-type actuators. Electrical actuator 32 can allow for selective control of fluid communication between drain orifice 50 and control chamber 92; fill orifice 52 and control chamber 92; drain line 58 and control chamber 94; and/or fill orifice 64 and control chamber 94. The actuator(s) can allow for selective control based on opening and closing of, for example, two-way or three-way valves associated with drain orifice 50, drain orifice 58, fill line 52, and/or fill line 64. In the example shown in FIG. 1, a single electrical actuator 32 is shown for controlling the movement of both gaseous-fuel check needle 38 and diesel-fuel check needle 42. In other embodiments, separate electrical actuators can be used to operate the separate check needles within an injector. The operation of electrical actuator (and/or other actuators) can be controlled by an electronic control module 164, as will be discussed in more detail in connection with FIG. 8 below.

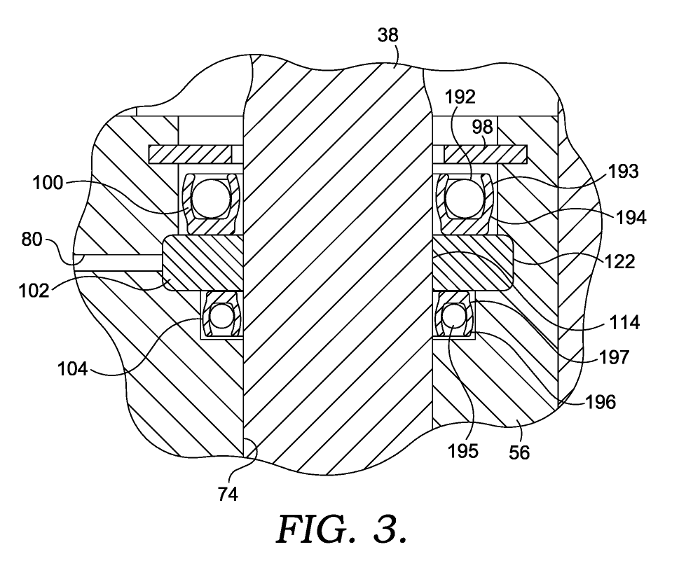

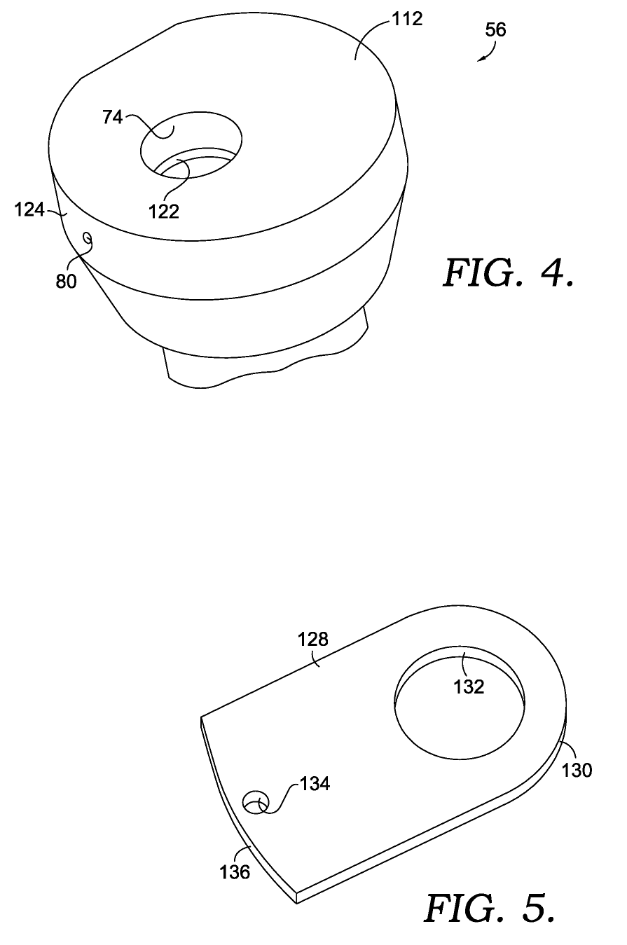

The gaseous-fuel check needle 38 is at least partially disposed in diesel-fuel check reservoir 90 and at least partially disposed in gaseous-fuel check cavity 186. Between diesel-fuel check reservoir 90 and gaseous-fuel check cavity 186, gaseous-fuel check needle 38 passes through a channel 74 in fuel check guide 56. The channel 74 in fuel check guide 56 provides a potential pathway for fluid communication between diesel-fuel check reservoir 90 and gaseous-fuel check cavity 186. This type of fluid communication can be prevented by using a plurality of sealing members. FIGS. 3 and 4 show an exemplary embodiment of using a plurality of sealing members to reduce, minimize, or prevent fluid communication between diesel-fuel check reservoir 90 and gaseous-fuel check cavity 186, so that commingling of diesel fuel and gaseous fuel can be substantially avoided.

In FIG. 3, gaseous-fuel check needle 38 is shown passing through a plurality of sealing members that are located in the channel 74 in fuel check guide 56. A sealing member 100 (i.e., first sealing member) can correspond to a seal suitable for sealing against flow of a pressurized liquid, such as diesel fuel pressurized at about 40 MPa. A sealing member 104 (i.e., second sealing member) corresponds to a seal suitable for sealing against flow of a pressurized gas, such as a gaseous fuel pressurized at about 35 MPa. Sealing member 100 can be configured as a static seal that can be adapted to withstand rapid pressure changes within the injector 10. Similarly, sealing member 104 can be configured as a static seal that can be adapted to withstand rapid pressure changes within the injector 10. Alternatively, one or both of sealing member 100 and sealing member 104 can be configured as a dynamic seal. Based on the fuel pressures that are typically present within a fuel injector, the sealing member 100 and/or the sealing member 104 can be pressure-assisted seals. For example, sealing member 100 and/or sealing member 104 can correspond to an O-ring seal that is capable of providing a constant seal in environments where there can be rapid temperature and pressure changes. In FIG. 3, sealing member 100 is shown as pressure-assisted O-ring seal 194 having an external u-shape casing 193. An O-ring spring 192 inside the O-ring seal 194 can help to set the initial loading. Similarly, sealing member 104 is shown as a pressure-assisted O-ring seal 197 having an external u-shape casing 196. An O-ring spring 195 inside the seal can help to set the initial loading. The external u-shape of sealing member 100 and sealing member 104 can assist with forming a seal when pressure is present. Examples of suitable seals for sealing member 104 can include pressure-assisted seals available from Parker Hannifin Corporation, such as an O-ring seal comprising a stainless steel spring with a carbon and/or graphite loaded polytetrafluorethylene casing.

During operation, such as when pressurized diesel fuel is present in diesel-fuel check reservoir 90, sealing member 100 can be disposed in a constant line of contact around the exterior of the gaseous-fuel check needle 38 and in a constant line of contact with an internal surface of channel 74 of fuel check guide 56. During operation, such as when pressurized gaseous fuel is present in gaseous-fuel check cavity 186, sealing member 104 can be disposed in a constant line of contact around the exterior of the gaseous-fuel check needle 38 and in a constant line of contact with an internal surface of channel 74 of fuel check guide 56. In some aspects, the sealing member 104 can also be resistant to explosive decompression. Sealing member 104 can correspond to an explosive decompression-resistant seal that can maintain seal integrity during this type of rapid gaseous pressure change.

In the embodiment shown in FIG. 3, sealing member 100 and sealing member 104 are separated by an intermediate volume 122 containing a backing ring 102. The nature of the intermediate volume 122 is further illustrated in FIG. 4, which schematically shows a perspective view of fuel check guide 56. In the view shown in FIG. 4, the channel 74 for the fuel check needle is empty so that the interior of the channel 74 is visible. The backing ring 102 is also not included in FIG. 4 so that intermediate volume 122 can be shown more clearly. In the view shown in FIG. 4, the top surface 112 can correspond to, for example, the retaining ring 98 as shown in FIG. 3. Weep channel 80 extends from an exterior surface 124 of fuel check guide 56 to the intermediate volume 122. Weep channel 80 can allow fuel that has entered into intermediate volume 122 to pass through fuel check guide 56 and exit to exterior surface 124.

Referring again to FIG. 3, backing ring 102 can provide structural support for sealing member 100 and/or sealing member 104. In contrast to sealing member 100 and sealing member 104, during operation of the injector the backing ring 102 is not in contact with the surface of gaseous-fuel check needle 38. Instead, a gap 114 having a specified tolerance is present between the facing surface of backing ring 102 and the surface of gaseous-fuel check needle 38. The gap 114 can be large enough to allow gaseous-fuel check needle 38 to pass through without contacting the backing ring 102. The gap can also be small enough to provide a desired level of support for sealing member 100 and/or sealing member 104. A suitable diametrical gap clearance between the backing ring and the gaseous-fuel check needle can be about 20 μm to about 130 μm. It is noted that because the sealing member 100 and the sealing member 104 are separate parts from fuel check guide 56, the diametrical gap 114 can have a relaxed tolerance (i.e., larger gap) relative to the tolerance for the fuel check guide.

During operation, the backing ring 102 can be in contact with and provide support for both sealing member 100 and sealing member 104. Because the backing ring 102 is providing support for both seals, during normal operation both sealing member 100 and sealing member 104 can be exposed to similar pressures, so that the differential in the pressure on sealing member 100 versus sealing member 104 is about 5 MPa or less. This can reduce the amount of force that is supported by backing ring 102 during normal operation. However, it should be expected that there will be times when the backing ring 102 may experience all of the force from a single fuel due to only one of the pressurized fuels being present within the injector. The backing ring 102 can be designed to have sufficient structural integrity to support sealing member 100 and/or sealing member 104 in situations where only one sealing member is exposed to a pressurized fuel.

The intermediate volume 122 between sealing member 100 and sealing member 104 can also serve as a weep annulus. If a fuel enters the intermediate volume 122 between sealing member 100 and sealing member 104, the fuel can exit from the intermediate volume 122 to an exterior surface 124 of fuel check guide 56. In the example shown in FIGS. 3 and 4, weep channel 80 allows fuel in the intermediate volume 122 to pass to the exterior surface 124 of fuel check guide 56. This can facilitate detection of fuel that has leaked past either sealing member 100 or sealing member 104 during operation of the injector and/or reduce or minimize passage of fuel from the intermediate volume 122 into further locations within the injector.

Other support structures can also be used to support and/or maintain the position of sealing member 100 and/or sealing member 104. As an example, the embodiment shown in FIG. 3 includes a retaining ring 98 positioned adjacent to a surface of sealing member 100. The clearance between retaining ring 98 and gaseous-fuel check needle 38 can be larger than the clearance for backing ring 102. This is due in part to retaining ring 98 being on the pressurized side of sealing member 100.

The embodiment shown in FIGS. 3 and 4 represents an example of a configuration for providing a plurality of sealing members for a fuel check needle. To assemble the configuration shown in FIGS. 3 and 4, the sealing member 104, backing ring 102, sealing member 100, and retaining ring 98 can be consecutively placed in channel 74. However, this type of assembly can potentially limit the material choices for the backing ring 102. For example, it can be desirable for the size of backing ring 102 to be larger than the size of sealing member 100 and/or larger than the size of channel 74. In such an embodiment, insertion of a backing ring 102 having a larger size than channel 74 may require backing ring 102 to be composed of an at least partially flexible material. A backing ring 102 composed of a sufficiently flexible material can be deformed to pass through an opening sized for sealing member 100.

An alternative manufacturing option can be to allow backing ring 102 to be inserted through an exterior surface 124 of fuel check guide 56. This can allow the backing ring 102 to be composed of a rigid material, such as a steel or ceramic material. FIG. 5 shows a perspective view of an example of a backing ring 128 suitable for insertion through an exterior surface 124 (as shown in FIG. 4) of fuel check guide 56. In the embodiment shown in FIG. 5, backing ring 128 includes a first ring portion 130 that surrounds opening 132 to provide support for sealing members. Backing ring 128 also includes an insertion surface 136. Insertion surface 136 can include at least one alignment hole 134. In this discussion, only one alignment hole is depicted for clarity in understanding the various drawings. In other embodiments, insertion surface 136 can include a plurality of alignment holes. Due to the small clearance between the opening 132 in backing ring 128 and the gaseous-fuel check needle 38, use of at least one (or a plurality of) alignment holes with corresponding alignment pins can provide a suitable method for maintaining a position and/or orientation of backing ring 128 relative to the expected travel path of gaseous-fuel check needle 38. In some aspects, it is appreciated that a plurality of alignment holes 128 can be beneficial for providing a suitable method for alignment.

The insertion of a backing ring 128 is shown in FIG. 7. In FIG. 7, fuel check guide 56 includes an insertion slot 182 to allow backing ring 128 to be inserted into intermediate volume 122 through the side of fuel check guide 56. As shown in FIG. 7, backing ring 128 can be removably inserted into intermediate volume 122 using insertion slot 182 without requiring removal of sealing member 100 or sealing member 104.

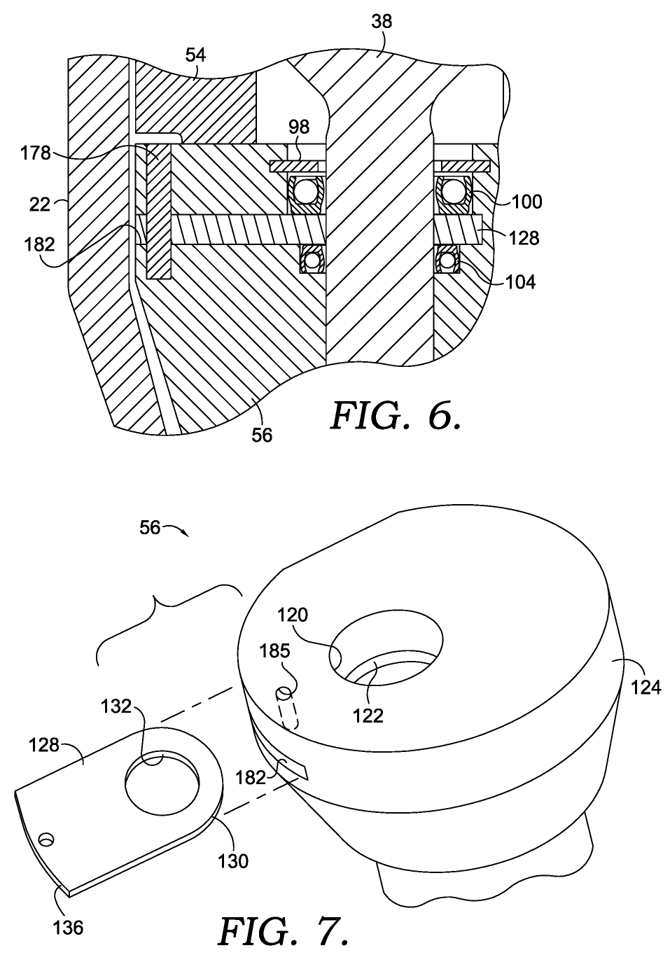

FIG. 6 shows additional details regarding a configuration where a backing ring 128 may be inserted into the intermediate volume between sealing member 100 and sealing member 104 through an exterior surface 124 of fuel check guide 56. At least a portion of backing ring 128 can reside in the insertion slot 182. The at least one alignment hole 134 can be located on a portion of insertion surface 136 (not shown in FIG. 6) that is disposed in the insertion slot 182. In the embodiment shown in FIG. 6, alignment pin(s) 178 can be inserted through the alignment hole(s) 134 (not shown in FIG. 6) to maintain a desired orientation and/or location for backing ring 128. For example, alignment pin(s) 178 can assist with maintaining a backing ring 128 in a desired plane, assist with maintaining the location of opening 132 at the expected location for gaseous-fuel check needle 38, or a combination thereof. In the embodiment shown in FIG. 6, backing ring 128 can be inserted prior to assembly of an exterior casing 22 around the injector 10.

A dual fuel injector, such as the embodiment of a injector 10 illustrated in FIGS. 1 and 2, can be used to provide fuel to combustion chambers of a dual fuel engine. In some dual fuel engines, it is desirable to operate the engine using a gaseous fuel, such as natural gas, but to initiate combustion by compression ignition (i.e., without requiring a spark or other combustion initiator). In such engines, a small amount of diesel fuel can be injected into the combustion chamber prior to injection of the gaseous fuel in order to facilitate compression ignition.

During dual fuel operation of an engine, injector 10 can be operated to first inject a desired amount of diesel fuel into a combustion chamber of an engine, followed by injection of a desired amount of a gaseous fuel into the combustion chamber. To operate in this manner, electrical actuator 32 can activate the movement of diesel-fuel check needle 42 and gaseous-fuel check needle 38 to allow for consecutive introduction of the respective fuels into the combustion chamber.

At the start of a combustion cycle, gaseous-fuel check needle 38 can be in a first position that prevents fluid communication between gaseous-fuel check cavity 186 and gaseous-fuel orifices 66. Diesel-fuel check needle 42 can also be in a first position that prevents fluid communication between diesel-fuel check cavity 188 and diesel-fuel orifices 166. To initiate fuel injection, electronic control module 164 (shown in FIG. 8) can energize electrical actuator 32 to open a control valve associated with drain orifice 58. This can allow the diesel fuel pressure in control chamber 94 to be reduced due to fluid communication between control chamber 94 and drain line 28. This causes diesel-fuel check needle 42 to move from the first position to the second position. Diesel fuel is then injected from diesel-fuel check cavity 188 into the engine combustion chamber for a desired period of time. To stop the injection of diesel fuel, electrical actuator 32 can close the valve associated with drain orifice 58. This can allow control chamber 94 to be re-pressurized to an initial control chamber pressure through a fill orifice 64 by introducing additional diesel pressure via fill line 34. In combination with the restoring force of biasing spring 46, the increase in pressure in control chamber 94 to the initial control chamber pressure can return diesel-fuel check needle 42 to the first position.

Electrical actuator 32 can coordinate the movement of diesel-fuel check needle 42 to the first position with movement of gaseous-fuel check needle 38 to the second position. Any convenient timing can be used for coordinating these movements, so that gaseous fuel is injected into the combustion chamber at a desired time relative to the injection of diesel fuel. For movement of the gaseous-fuel check needle to the second position, electronic control module 164 (shown in FIG. 8) can energize electrical actuator 32 to open a valve associated with drain orifice 50. This can allow the diesel fuel pressure in control chamber 92 to be reduced due to fluid communication between control chamber 92 via drain line 26. This causes gaseous-fuel check needle 38 to move from the first position to the second position. Gaseous fuel is then injected from gaseous-fuel check cavity 186 into the engine combustion chamber for a desired period of time. To stop the injection of gaseous fuel, electrical actuator 32 can close the valve associated with drain orifice 50. This can allow control chamber 92 to be re-pressurized to an initial control chamber pressure through fill orifice 52 by introducing additional diesel pressure via fill line 34. In combination with the restoring force of biasing spring 48, the increase in pressure in control chamber 92 to the initial control chamber pressure can return gaseous-fuel check needle 38 to the first position.

FIG. 8 schematically shows an example of a dual fuel common rail fuel system 138 utilizing a dual fuel common rail injector 150. The embodiment of a dual fuel common rail fuel system 138 in FIG. 8 can be used to provide fuel to a dual fuel common rail injector 150 during operation of a dual fuel engine. In various aspects, a dual fuel common rail injector 150 may correspond to an injector 10 as illustrated in FIG. 1. For ease of discussion of FIG. 8, the dual fuel common rail injector will be referred to as “injector 150”. A diesel fuel source 162 contains diesel fuel. A diesel pump 158 draws diesel fuel from diesel fuel 162, pressurizes the diesel fuel, and delivers the pressurized diesel fuel through diesel supply line 156 to a diesel-fuel rail 152. A filter 160 may be disposed upstream of the diesel pump 158 and downstream of the diesel fuel source 162. Diesel fuel within the diesel-fuel rail 152 may be pressurized to a pressure of approximately 40 MPa. Pressurized diesel fuel from the diesel-fuel rail 152 may then be delivered to a quill assembly 144 via diesel fuel line 142. Quill assembly 144 is configured to receive both diesel fuel and a gaseous fuel such as vaporized liquefied natural gas. Those skilled in the art will recognize that the gaseous fuel may be any gaseous fuel such as natural gas, propane, methane, liquefied petroleum gas (LPG), synthetic gas, landfill gas, coal gas, biogas from agricultural anaerobic digesters, or any other gaseous fuel. Diesel fuel from quill assembly 144 is then delivered to injector 150. Although quill assembly 144 is shown as a single quill assembly in FIG. 8, in various embodiments separate quill assemblies may be used for delivery of diesel fuel and gaseous fuel to injector 150.

Dual fuel common rail fuel system 138 further includes a gaseous fuel source 174. Gaseous fuel, such as liquefied natural gas may be stored at relatively low temperatures and pressures (−160° C. and 100 kPa). Because gaseous fuel may be stored under such temperatures and pressures, it may be necessary for the gaseous fuel to be kept in a vacuum insulated tank. Gaseous fuel is drawn from gaseous fuel source 174 through a gaseous supply line 168 by a gaseous-fuel pump 172. In aspects where gaseous fuel source stores the gaseous fuel in a liquid state, vaporizer 170 can vaporize the fuel from the liquid phase to the gas phase. Gaseous-fuel pump 172 may be a variable displacement cryogenic pump. Gaseous-fuel pump 172 pressurizes and delivers gaseous fuel to an accumulator 176 via gaseous supply line 168. A pressure regulator 166 ensures that gaseous fuel delivered to a gaseous-fuel rail 154 is at a pressure that is at least 5 MPa below that of the diesel fuel within the diesel-fuel rail 152 via gaseous fuel line 140. For example, within the dual fuel common rail fuel system 138, diesel fuel within the diesel-fuel rail 152 may be at a pressure of 40 MPa, while gaseous fuel within the gaseous-fuel rail 154 may be at a pressure of 35 MPa.

An electronic control module (ECM) 164 may control various components of dual fuel common rail fuel system 138. For example, the ECM 164 may control the electrical actuator 32 of injector 150. Likewise, the ECM 164 may also control components such as the diesel pump 158, gaseous-fuel pump 172, and pressure regulator 166. Those skilled in the art will recognize that fuel system may further include other components that can also be controlled by ECM 164.

In an embodiment where an injector 10 according to FIG. 1 is used as injector 150, first quill tube 146 can deliver diesel fuel to diesel-fuel supply inlet 16. The diesel fuel can then be passed from diesel-fuel supply inlet 16 to various locations in the injector 10 via, for example, diesel-fuel supply passage 18. Second quill tube 148 can deliver gaseous fuel to gaseous-fuel supply inlet 12. The gaseous fuel can then be passed from gaseous-fuel supply inlet 12 to various locations in the injector 10 via, for example, gaseous-fuel supply passage 20.

### INDUSTRIAL APPLICABILITY

A dual fuel injector having a plurality of sealing members as described herein can generally be used with any engine that can independently receive two fuels (e.g., diesel and natural gas). These two fuels may be the same fuel at two different pressures, or may, as in the illustrated embodiment, be different fuels. One example of a suitable application is in gaseous fuel engines that utilize a relatively large charge of natural gas that is ignited via compression ignition of a small charge of distillate diesel fuel originating from diesel-fuel rail 152. Optionally, such an engine could also be operated for a limited period of time in a “diesel-only” mode, where only diesel fuel is combusted, as the sealing members described herein can also be effective in preventing diesel migration into gaseous-fuel portions of an injector even when gaseous fuel is absent from the injector for extended periods of time. In some alternative aspects, dual fuel injectors as described herein could also apply to spark ignited engines utilizing appropriate fuels.

In FIGS. 3 and 6, the sealing member 100 is configured to substantially prevent diesel fuel from leaking from the diesel-fuel check reservoir 90 into the gaseous-fuel check cavity 186 via channel 74 in fuel check guide 56. During operation, the sealing member 100 is configured to have a constant line of contact around the channel 74 and the gaseous-fuel check needle 38. In this manner, diesel fuel leaks may be substantially prevented from percolating or dripping from the diesel-fuel check reservoir 90 and draining along the channel 74 into the gaseous-fuel check cavity 186.

In FIGS. 3 and 6, sealing member 104 is configured to prevent gaseous fuel from leaking from gaseous-fuel check cavity 186 into diesel-fuel check reservoir 90. In various embodiments described herein, the pressure in diesel-fuel check reservoir 90 can be greater than the pressure in gaseous-fuel check cavity 186. However, the pressure in diesel-fuel check reservoir 90 may temporarily fall below the pressure in gaseous-fuel check cavity 186. Also, due to the compressible nature of gas and the incompressible nature of liquids, during engine shutdown the diesel fuel pressure may decay faster than the gaseous fuel pressure, which could potentially allow gas to expand from gaseous-fuel check cavity 186 along channel 74 into the diesel side of the fuel system. This can result in diesel being displaced with gaseous fuel, which can potentially lead to a variety of problems, such as difficulty in pressurizing the diesel system. During operation, the sealing member 104 is configured to have a constant line of contact around the channel 74 and the gaseous-fuel check needle 38. In this manner, gaseous fuel leaks may be inhibited from migrating along the channel 74 into the diesel fuel reservoir. In alternative aspects where different fuels are used at a similar pressure, sealing member 104 can also inhibit migration of gaseous fuel into the diesel-fuel check reservoir 90 during normal periods of operation.

In FIG. 3, the intermediate volume 122 between the sealing member 100 and the sealing member 104 can be in fluid communication with an exterior surface 124 (as shown in FIG. 4) of the fuel check guide 56 and/or another exterior surface via a weep channel 80. In the event that a fuel does leak past sealing member 100 and/or sealing member 104, weep channel 80 can allow such fuel to be detected at exterior surface 124.

In FIG. 6, insertion slot 182 can provide advantages similar to weep channel 80. Additionally, insertion slot 182 can facilitate manufacturing of an injector having sealing member 100, backing ring 102, and sealing member 104 by allowing for insertion of backing ring 102 through a side of fuel check guide 56. This can avoid the need to form backing ring 102 from a material that can be deformed sufficiently to pass through channel 74.

The present description is for illustrative purposes only, and should not be construed to narrow the breadth of the present disclosure in any way. Thus, those skilled in the art will appreciate that various modifications might be made to the presently disclosed embodiments without departing from the full and fair scope and spirit of the present disclosure. Other aspects, features and advantages will be apparent upon an examination of the attached drawings and appended claims.

What is claimed is:

1. A dual fuel injector, comprising:
an injector body configured to receive a first fuel and a second fuel;
a nozzle having a first set of orifices for injecting the first fuel and a second set of orifices for injecting the second fuel;
a first-fuel check needle at least partially disposed in a first-fuel check reservoir;
a second-fuel check needle at least partially disposed in a second-fuel check cavity and at least partially disposed in the first-fuel check reservoir;
a first sealing member disposed around the exterior of the second-fuel check needle, the first sealing member configured to prevent the first fuel from leaking from the first-fuel check reservoir into the second-fuel check cavity;
a second sealing member disposed around an exterior of the second-fuel check needle and between the second-fuel check cavity and the first-fuel check reservoir, the second sealing member configured to prevent the second fuel from leaking from the second-fuel check cavity into the first-fuel check reservoir;
a backing ring disposed around the exterior of the second-fuel check needle in an intermediate volume between the first sealing member and the second sealing member; and
a conduit from the intermediate volume to an exterior surface of a fuel check guide.

2. The dual fuel injector of claim 1, wherein the first sealing member is disposed in a constant line of contact around the exterior of the second-fuel check needle and in a constant line of contact with an internal surface of the fuel check guide.

3. The dual fuel injector of claim 1, wherein the second sealing member is disposed in a constant line of contact around the exterior of the second-fuel check needle and in a constant line of contact with an internal surface of the fuel check guide.

4. The dual fuel injector of claim 1, wherein at least one of the first sealing member and the second sealing member comprises a pressure-assisted sealing member.

5. The dual fuel injector of claim 1, wherein a clearance between the first surface of the backing ring and the exterior of the second-fuel check needle is about 20 μm to about 130 μm.

6. The dual fuel injector of claim 1, wherein the backing ring is removably inserted into the intermediate volume by insertion through the conduit.

7. The dual fuel injector of claim 6, wherein the backing ring further comprises an insertion surface, at least a portion of the insertion surface being disposed in the conduit.

8. The dual fuel injector of claim 7, further comprising at least one backing ring alignment pin disposed in at least one alignment hole in the insertion surface.

9. The dual fuel injector of claim 1, further comprising a retaining ring disposed around the exterior of the second-fuel check needle and adjacent to a first surface of the first sealing member.

10. The dual fuel injector of claim 1, wherein the second sealing member comprises an explosive decompression-resistant sealing member.

11. The dual fuel injector of claim 1, further including a first biasing spring configured to bias the first-fuel check needle toward a first position, and further includes a second biasing spring configured to bias the second-fuel check needle toward a first position.

12. The dual fuel injector of claim 1, wherein the second-fuel check needle is movable between a first position wherein the second-fuel check needle blocks fluid communication with the second set of orifices, and a second position wherein the second-fuel check needle at least partially allows fluid communication with the second set of orifices.

13. The dual fuel injector of claim 1, wherein the first-fuel check needle is movable between a first position wherein the first-fuel check needle blocks fluid communication with the first set of orifices, and a second position wherein the first-fuel check needle at least partially allows fluid communication with the first set of orifices.

14. The dual fuel injector of claim 1, further comprising a first-fuel check cavity in fluid communication with the first-fuel check reservoir.

15. The dual fuel injector of claim 1, wherein the first fuel is diesel fuel and the second fuel is a gaseous fuel.

16. A dual fuel common rail fuel system comprising:
a first-fuel source;
a second-fuel source;
a first-fuel rail;
a second-fuel rail;
at least one first-fuel pump configured to pressurize a first fuel from the first-fuel source and deliver the first fuel to the first-fuel rail;
at least one second-fuel pump configured to pressurize a second fuel from the second-fuel source and deliver the second fuel to the second-fuel rail;
a dual fuel injector fluidly coupled to the first-fuel rail and to the second-fuel rail, and further comprising:
an injector body configured to receive the first fuel from the first-fuel source and the second fuel from the second-fuel source;
a nozzle having a first set of orifices for injecting the first fuel and a second set of orifices for injecting the second fuel;
a first-fuel check needle at least partially disposed in a first-fuel check reservoir;
a second-fuel check needle at least partially disposed in a second-fuel check cavity and at least partially disposed in the first-fuel check reservoir;
a first sealing member disposed around the exterior of the second-fuel check needle, the first sealing member configured to prevent the first fuel from leaking from the first-fuel check reservoir into the second-fuel check cavity;
a second sealing member disposed around an exterior of the second-fuel check needle and between the second-fuel check cavity and the first-fuel check reservoir, the second sealing member configured to prevent the second fuel from leaking from the second-fuel check cavity into the first-fuel check reservoir;
a backing ring disposed around the exterior of the second-fuel check needle in an intermediate volume between the first sealing member and the second sealing member; and
a conduit from the intermediate volume to an exterior surface of a fuel check guide.

17. The dual fuel injector of claim 16, wherein at least one of the first sealing member and the second sealing member is disposed in a constant line of contact around the exterior of the second-fuel check needle and in a constant line of contact with an internal surface of the second-fuel check cavity.

18. The dual fuel injector of claim 16, wherein a clearance between the first surface of the backing ring and the exterior of the second-fuel check needle is about 20 μm to about 130 μm.

19. The dual fuel injector of claim 16, wherein the backing ring is removably inserted into the intermediate volume by insertion through the conduit, the backing ring further comprising an insertion surface having at least one alignment hole, at least a portion of the insertion surface being disposed in the conduit.

20. A dual fuel engine system comprising:
a first-fuel source;
a second-fuel source;
a first-fuel rail;
a second-fuel rail;
at least one first-fuel pump configured to pressurize a first fuel from the first-fuel source and deliver the first fuel to the first-fuel rail; and
at least one second-fuel pump configured to pressurize a second fuel from the second-fuel source and deliver the second fuel to the second-fuel rail;
a dual fuel engine comprising at least one dual fuel injector fluidly coupled to the second-fuel rail and to the first-fuel rail, the at least one dual fuel injector further comprising:
an injector body configured to receive the first fuel from the first-fuel source and the second fuel from the second-fuel source;
a nozzle having a first set of orifices for injecting the first fuel and a second set of orifices for injecting the second fuel;
a first-fuel check needle at least partially disposed in a first-fuel check reservoir;
a second-fuel check needle at least partially disposed in a second-fuel check cavity and at least partially disposed in the first-fuel check reservoir;
a first sealing member disposed around the exterior of the second-fuel check needle, the first sealing member configured to prevent the first fuel from leaking from the first-fuel check reservoir into the second-fuel check cavity;
a second sealing member disposed around an exterior of the second-fuel check needle and between the second-fuel check cavity and the first-fuel check reservoir, the second sealing member configured to prevent the second fuel from leaking from the second-fuel check cavity into the first-fuel check reservoir;
a backing ring disposed around the exterior of the second-fuel check needle in an intermediate volume between the first sealing member and the second sealing member; and
a conduit from the intermediate volume to an exterior surface of a fuel check guide.
